(19) United States
(12) Patent Application Publication
(10) Pub. No.: US 2024/0313644 A1
(43) Pub. Date: Sep. 19, 2024

(54) PLANAR ELECTRO-MAGNETIC DEVICES

(71) Applicant: The Trustees of Indiana University, Bloomington, IN (US)

(72) Inventors: Euzeli Cipriano dos Santos, Jr., Zionsville, IN (US); Rajesh Sardar, Avon, IN (US); Haitham Kanakri, Bloomington, IN (US)

(21) Appl. No.: 18/434,035

(22) Filed: Feb. 6, 2024

Related U.S. Application Data
(60) Provisional application No. 63/484,235, filed on Feb. 10, 2023.

(51) Int. Cl. H02M 3/00; B82Y 30/00; B82Y 40/00; H01F 27/28; H02M 3/158; H02M 7/00

(52) U.S. Cl. CPC H02M 3/003; H01F 27/2847; H02M 7/003; B82Y 30/00; B82Y 40/00; H02M 3/01; H02M 3/1582

(57) ABSTRACT

Provided is planar electro-magnetic device with both inductive and capacitive characteristics comprising a calcium copper titanate CCTO nanoparticle film. The planar electro-magnetic device may be used in a circuit of a power electronic device, such as a converter, signal electronic, and/or communication device. Further, a method of making the CCTO nanoparticle film is provided. The method comprising combining gOLAc and OLAm, heating the OLAc and OLAm, adding metal alkoxide precursors to the OLAc and OLAm to create CCTO NPs, purifying the CCTO NPs, adding sulfide ions to the NP, dispersing the sulfide ion passivated CCTO NP in solvent, and spin coating a film of CCTO NP onto aluminum foil.

### CROSS-REFERENCE TO RELATED APPLICATIONS

This application claims the benefit under 35 U.S.C. § 119(e) of U.S. Provisional Application No. 63/484,235 filed on Feb. 10, 2023, which is incorporated by reference in its entirety.

### FIELD

The present disclosure relates generally to planar electro-magnetic devices comprising a CCTO NP film. The planar electro-magnetic devices may be included in power electronic device circuits such that the power electronic device has parasitic components. Further, the present disclosure relates to methods of designing such PEDs.

### BACKGROUND

To meet the ever-increasing energy demands and ongoing market needs, it has become important to design and construct power electronic devices such as power converters with high efficiency. Furthermore, space is limited, thus, smaller converters are desirable.

One pursuit in the power electronics field is to reduce the size of the power supply while maintaining high power density. In many applications there is a continuous pressure to do more with less, which means to provide more power with less physical volume. To a large extent, miniaturization of power supplies will continue to equip new applications and markets.

Planar magnetics have replaced many conventional “wire-round-bobbin” transformers and inductors. Transformers with planar magnetics may have higher efficiency; lower leakage inductance; lower profile and small volume with high power density; higher frequency range operation; increased repeatability and predictability; higher efficient heat dissipation and cooling; lower weight; and lower EMI than traditional wire-wound-on-a-bobbin transformers.

An important metric to measure miniaturization is power density, which is quantifiable as the amount of power processed per unit volume. Known improvements in the power electronics field have been achieved by reducing switching losses; improving package thermal performance; adopting innovative topologies and circuits; and developing better and more efficient discrete devices.

Known power converters may use power devices and techniques that require discrete components to accomplish specific goals. Yet, inherent interactions between electric and magnetic fields create parasitic components, which becomes a limiting factor towards designing discrete elements. Planar magnetics are particularly used in high power density converters, however the constructed converters experience high built-in parasitic capacitance. There is a general effort in known power converters to minimize parasitic elements. However, designing to avoid parasitic elements may frustrate the other design goals of power converters. Thus, a converter that is designed to embrace inherent parasitic elements is needed in the field of power electronics.

### SUMMARY

The present disclosure provides a planar electro-magnetic device, including: at least two outer solder masks; and a plurality of layers of copper sheets. Each layer of copper sheet is spaced apart by at least one or a combination of a ferromagnetic core, an internal insulator, and a calcium copper titanate (CCTO) nanoparticle film. Further, each of the plurality of layers of copper sheets are spaced apart between the first and second outer solder mask. The planar converter has both inductive and capacitive characteristics.

The present disclosure also provides a power electronic device circuit, including: a voltage source; at least one resistor; at least one inductor; and a planar electro-magnetic device (PED). The inductor includes capacitive characteristics such that the power electronic device does not need an external capacitor. Further, the PED includes at least two outer solder masks; a calcium copper titanate (CCTO) nanoparticle film; and a plurality of layers of copper sheets. Each layer of copper sheet is spaced apart by at least one or a combination of a ferromagnetic core, an internal insulator, and the CCTO nanoparticle film. Each of the plurality of layers of copper sheets are spaced apart between the first and second outer solder mask. The PED has both inductive and capacitive characteristics.

The present disclosure provides a method of forming a calcium copper titanate (CCTO) nanoparticle film, including: combining oleic acid (OLAc) and oleylamine (OLAm) to form a surface passivating ligand mixture; heating the surface passivating ligand mixture to about 300° C.; injecting metal alkoxide precursors into the surface passivating ligand mixture; reacting the surface passivating ligand mixture with sulfide ions (S2−) to create a passivated CCTO nanoparticle; dispersing the CCTO nanoparticle into an organic solvent to create a CCTO nanoparticle ink; and spin coating the CCTO nanoparticle ink onto an aluminum foil to create a CCTP nanoparticle film with a controllable thickness.

The present disclosure illustrates a method of designing capacitors and inductors without trying to eliminate parasitic components. The design changes purposely increase parasitic capacitance in an inductor and transformer. In one embodiment, the designing of capacitors and inductors for power electronics does not include capacitors. In another embodiment, the designing of capacitors and inductors comprises any circuit that requires inductive-capacitive elements without capacitors. In a further embodiment, the method further comprises the technique of synthesizing high dielectric constant material inside inductor and capacitor devices. In yet another embodiment, the method comprises designing a device with inductive and capacitive characteristics, mechanical robustness, and vibration resistance.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 illustrates a method of creating a CCTO NP film;

FIG. 2A illustrates a planar magnetic transformer with a planar layer structure of the present disclosure;

FIG. 2B illustrates a planar magnetic transformer with multiple layers of the planar layer structure of FIG. 2A;

FIG. 3A is a schematic diagram for a four layer overlapping layout of the planar structure within the ferromagnetic core window;

FIG. 3B is a schematic diagram for a three layer overlapping layout of the planar structure within the ferromagnetic core window;

FIG. 3C is a schematic diagram for a two layer overlapping layout of the planar structure within the ferromagnetic core window;

FIG. 3D is a schematic diagram for an alternating layer layout of the planar structure within the ferromagnetic core window;

FIG. 4 is a graph of the intra capacitance of each of the layouts in FIGS. 3A-D;

FIG. 5A is a schematic for known converter in which the inductor is modeled with the parasitic components presented in a known planar device;

FIG. 5B is a three-dimensional view of the schematic of FIG. 5A;

FIG. 5C is a graph of the voltage and current across the inductor of FIG. 5A;

FIG. 5D is a schematic for a converter in which the inductor is molded with the parasitic components presented in a planar device of the present disclosure;

FIG. 5E is a three-dimensional view of the schematic of FIG. 5D;

FIG. 5F is a graph of the voltage and current across the inductor of FIG. 5D;

FIG. 6A is a schematic of a known buck converter;

FIG. 6B is a schematic of a buck converter of the present disclosure;

FIG. 6C is a schematic of a known buck-boost converter; and

FIG. 6D is a schematic of a buck-boost converter of the present disclosure;

FIG. 7 illustrates a planar magnetic transformer with a planar layer structure of present disclosure with a CCTO layer on the right side of the device and a known insulator layer on the left side of the device;

FIG. 8A is a schematic of an LLC resonant cell used in isolated DC-DC converters;

converters;

FIG. 8B is a schematic of an LLC resonant cell used in isolated DC-DC

FIG. 8C is a schematic of an LCC resonant cell used in isolated DC-DC converters;

FIG. 8D is a schematic of an LCC resonant cell used in isolated DC-DC converters;

FIG. 9A is a schematic of an LLC resonant converter with a conventional resonant cell;

FIG. 9B is a schematic of an LLC resonant converter with the resonant cell of the present disclosure;

FIG. 9C is a schematic of a DC-AC power converter with a conventional LCL filter; and

FIG. 9D is a schematic of a DC-AC power converter with a planar LCL filter of the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The present disclosure challenges the need to reduce parasitic components in planar magnetics and provides a planar electromagnetic device (PED) that allows for both capacitive and inductive characteristics. The PEDs comprise a calcium copper titanate nanoparticle film.

Calcium copper titanate (CCTO) nanoparticles (NPs) may be integrated into thin layer films to create a dielectric material. The CCTO NP film may have high dielectric characteristics and therefore increase parasitic capacitance in PEDs. Such enhanced PEDs with higher capacitive values may be used to build high power density power electronics converters.

To achieve a compact yet high power density power converter, the present disclosure may include multidimensional variables and embraces inherent parasitic components as part of the design and operation of the components.

The present disclosure provides a PED with both inductive and capacitive characteristics. In one embodiment, the PED comprises the CCTO NP dielectric material. In another embodiment, the PED comprises a ferromagnetic material with capacitive features in combination with the CCTO NP dielectric material.

The present disclosure illustrates a method of designing capacitors and inductors without trying to eliminate parasitic components. The design changes purposely increase parasitic capacitance in an inductor and transformer. In one embodiment, the designing of capacitors and inductors for power electronics does not include capacitors. In another embodiment, the designing of capacitors and inductors comprises any circuit that requires inductive-capacitive elements without capacitors. In a further embodiment, the method further comprises the technique of synthesizing high dielectric constant material inside inductor and capacitor devices. In yet another embodiment, the method comprises designing a device with inductive and capacitive characteristics, mechanical robustness, and vibration resistance.

### Synthesis of CCTO Nanoparticles Colloidal Inks for the Fabrication of Thin Films

The introduction of printed electronics may bring a new revolution in solid-state electronic device fabrication because of the flexibility and lightweight of the constructed device, case of integration into a large-scale production, and most importantly low material wastes that allow low-cost production. To acquire the new milestones in printed electronics, unique compositions of functional and stable colloidal inks, which are a stable dispersion form of nanoparticles (NPs) in solution, may be useful.

The stability of colloidal ink means the NPs must remain in the dispersion for an extended period of time. A stable colloidal ink may be achieved by passivating NP surface with organic and/or inorganic ligands. Ligands increase the steric and electrostatic interactions between NPs resulting in non-agglomerated dispersion that can be stable for more than six months.

The present disclosure presents a method of integrating calcium copper titanate (CCTO) materials into miniaturization of capacitor components by developing high temperature colloidal synthetic methods to prepare CCTO NPs. The present method 10 may prepare a 100-200 micrometer thin film of CCTO NP onto a conductive aluminum foil for the proposed device fabrication.

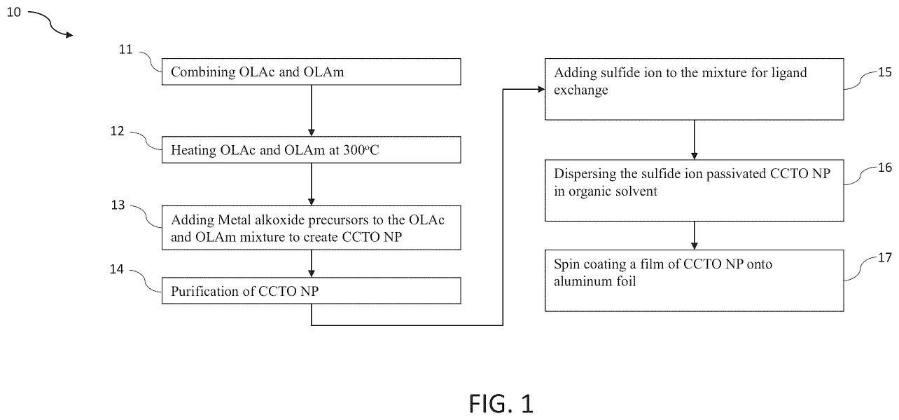

Referring now to FIG. 1, in step 11 of the method of producing a CCTO NP coated film, oleic acid (OLAc) and oleylamine (OLAm) may be mixed together. OLAc and OLAm may act as surface passivating ligands to control the size of the resulting NPs. In step 12, the mixture of OLAc and OLAm may be heated at 300° C. under N₂ followed by the injection of al: 1 mole ratio of metal alkoxide precursors in step 13. Metal alkoxide precursors may include Ca(II)-ethoxide, Cu(II)-ethoxide and Ti(IV)-ethoxide. By injecting metal alkoxide precursors into the mixture ligand-passivated CCTO NPs may form. In step 14, the CCTO NP may be purified by solvent extraction and centrifugation. The ligand-passivated CCTO NPs may undergo ligand exchange reaction with sulfide ion (S2−) to create S2− passivated CCTO NP, in step 15. To create the CCTO NP ink, in step 16, the S2− passivated CCTO NP may be dispersed in organic solvent. Finally, in step 17, the CCTO NP ink may be spin coated onto an aluminum foil to prepare the film with controllable thickness. The CCTO NP film may have a thickness of 100-200 nm. The coated NP ink may have a periodic arrangement of NPs in the three-dimensional film.

The method discussed above may synthesize high quality monodisperse NPs that cannot be prepared by other methods, such as ball milling and/or sol-gel chemistry. Moreover, materials prepared with ball milling and/or sol-gel techniques may be structurally and compositionally inhomogeneous.

Planar Electro-Magnetic Devices (PEDs) with Increased Parasitic Components

Although, calcium copper titanate (CCTO) materials have been used for energy store devices, gas sensors, antennae and GPS purposes, CCTO NPs are not usually used in the capacitorless power converter design and fabrication. The large grain size of commercially available micron length materials may not be suitable to achieve excellent electronic communication in the device construct. Therefore, the present disclosure uses a multidisciplinary approach involving chemistry, nanotechnology, and engineering to prepare CCTO materials as a form of nanoparticles (NPs), followed by the construction of PEDs comprising the CCTO NP film to integrate into the construction of proposed devices.

CCTO thin film may be prepared as a dielectric material. The CCTO thin film may be prepared by developing a high temperature colloidal synthetic method to prepare CCTO nanoparticles (NPs), conducting a surface modification approach to generate NPs colloidal ink, and preparing a thin film (˜100-200 nm thin) with strong inter-NP electronic communication, as discussed above with reference to method 10.

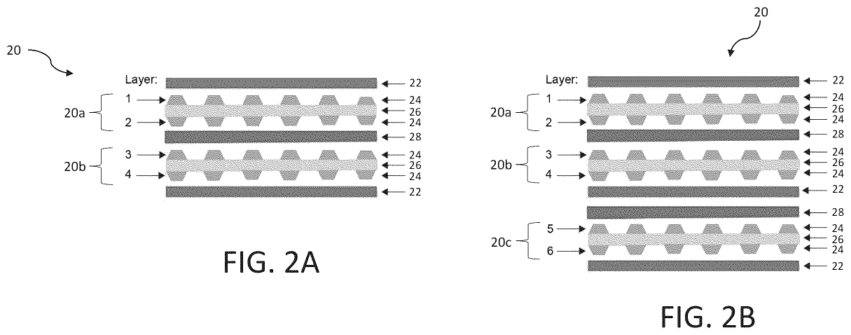

Known planar transformers have a planar structure with an internal insulator at the center of the layers. The PED may comprise at least one double-layer planar magnetic transformer 20. The double-layer planar magnetic transformer 20, as shown in FIG. 2A, may have a four-layer planar structure (not including the ferromagnetic (FR4) core 26), each numbered 1-4, with the internal insulator substituted by CCTO 28. While a first double-layer planar transformer 21a alone may provide a moderate increase on the parasitic capacitance, its implementation may be improved by adding a second double-layer planar transformer 21b. Each of the double-layer planar transformers 21a, 21b may have a FR4 insulator 26 in-between the first and second/third and fourth layers of the transformers 21a, 21b. Additionally, a layer of CCTO NP film 28 may separate the first double-layer planar transformer 21a from the second double-layer planar transformer 21b. The planar magnetic transformer 20 may comprise an outer solder mask 22, copper sheet 24, the FR4 core 26 and the CCTO film 28. The planar magnetic transformer may be used with multiple layers, as seen in FIG. 2B.

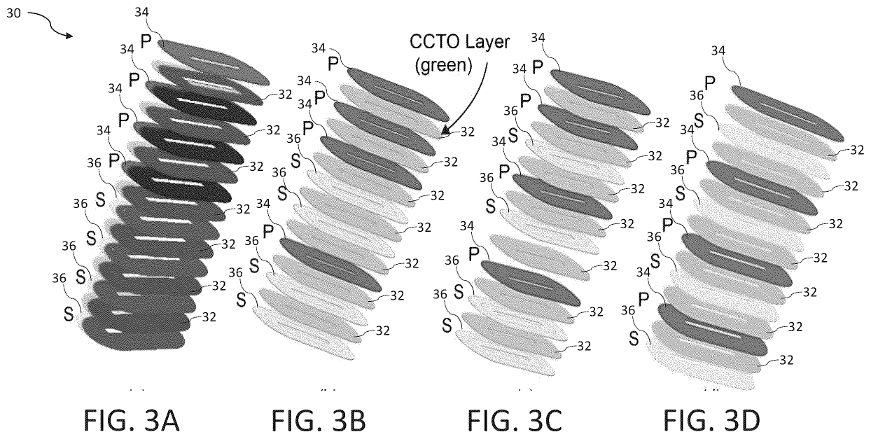

FIG. 3A-D show schematic diagrams for layouts of the planar structure within the ferromagnetic core window to maximize capacitive coupling. A CCTO layer 32 is spaced between primary windings 34 and secondary windings 36. FIG. 3A illustrates four layers of the same windings overlapping layout. FIG. 3B illustrates three layers of the same winding overlapping layout. FIG. 3C illustrates two layers of the same winding overlapping layout. FIG. 3D illustrates an alternating layers layout.

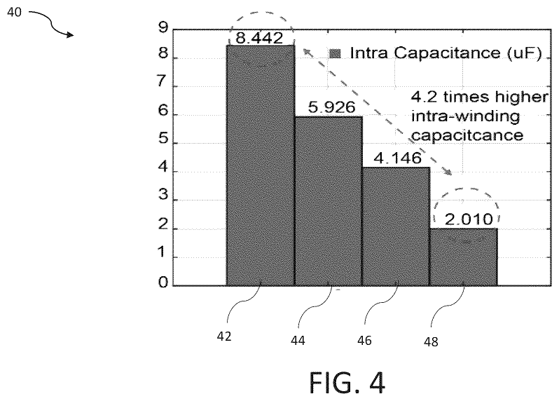

The capacitive coupling values for all inter and intra capacitances for the layouts of planar structure were tested and the results are displayed in graph 40, as seen in FIG. 4. The intra capacitance of alternating layers 42, as seen in FIG. 3D, was 4.2 times higher than the intra capacitance for: two layers overlap, as seen in FIG. 3C; three layers overlap, as seen in FIG. 3B; and four layers overlap, as seen in FIG. 3A. These results show a significant increase of intra winding capacitance by up to 4.2 higher in the case of alternating layers layout. There is a need to incorporate the effects of the type of connections between layers on the layout design, i.e., parallel, series and hybrid connections between windings.

### Capacitorless Power Electronics Converters

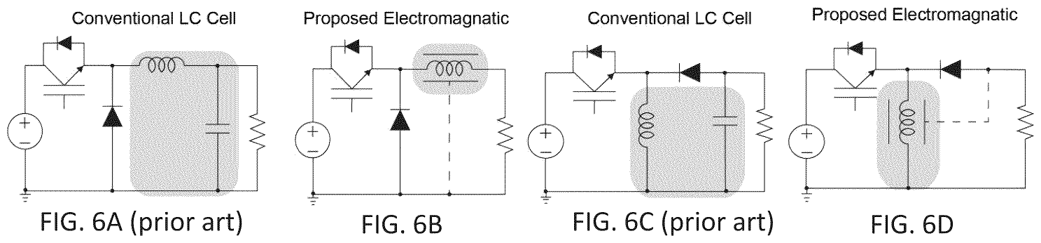

Most power electronics devices, such as converters, signal electronics, communication devices, etc., use semiconductor devices with an arrangement of inductive and capacitive elements to process power between either a source and a load or between two sources. Engineers, designers and researchers have focused on building close to ideal discrete components (e.g., switches, capacitors and inductors) and connecting them using predefined goals for specific features. Although the inductive-capacitive (LC) cell commonly needed in those power converters is built with discrete components, its dual characteristic is obtained in a collaborative operation as seen in FIGS. 6A and 6C. This shows traditional buck 6A and buck-boost 6C non-isolated DC-DC converters. The PED of the present disclosure combines both inductance and capacitance in a single structure, as seen in FIGS. 6B and 6D.

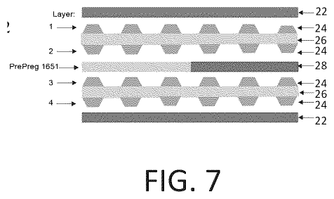

The PED of the present disclosure may be integrated into any power electronic device, such as converters, signal electronics, communication devices, and other suitable power electronic devices, circuit. The power electronic device circuit comprising the PED may lack an external capacitor, thereby reducing packaging space and increasing power density. Referring to a power electronic device comprising the PED, as seen in FIGS. 6B and 6D, the parasitic components at one terminal may be maximized while its values on the other terminal may be kept minimum. To accomplish maximizing the parasitic components at one terminal while minimizing the components at the other terminal, the insulator material between layers 2 and 3 may be replaced by CCTO only on the half right side of the device, as seen in FIG. 7. A known internal insulator, such as PrePreg 1651, may still be used on the left half of the device.

Another power converter that may take advantage of the LC structure is the resonant converters. Specifically, resonant converter topologies, by nature, use at least two, three or more LC cells, typically called a resonant tank. The L and C elements of the resonant tank are connected in series, parallel or in a hybrid arrangement. The operating frequency of the resonant tank allows to modulate its gain amplitude by changing the operating frequency to achieve buck or boost operation.

There may be three fundamental resonance LC cells: series resonance; parallel resonance; and notch resonance (a combination of series and parallel). The series LC cell has at least two reactive elements connected in series and cascaded between the input and the output. While in parallel LC resonance one of those reactive elements is connected in parallel with the cell output while the other element is connected in series between the input and the output. The notch resonance represents the case where the LC cell is connected in series and placed in parallel with the output or the LC cell is connected in parallel and placed in series with the output. Moreover, three reactive elements in the resonant tank, will lead to thirty-six possible resonant cells.

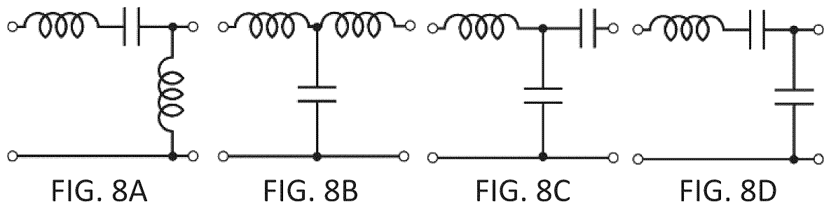

FIGS. 8A-D are schematics of known resonant tanks typically used in isolated DC-DC converters. FIGS. 8A and 8B show LLC (winding inductance, leakage inductance, and series capacitance) type of cells while FIGS. 8C and 8D show the LCC type of cells.

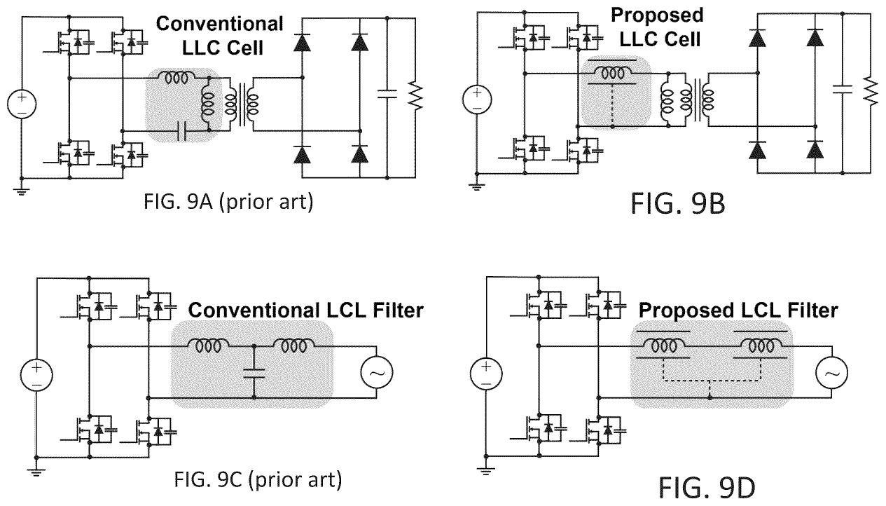

FIG. 9A shows an LLC resonant converter with a conventional resonant cell, while FIG. 9B presents an LLC resonant converter with the proposed resonant cell. FIG. 9C shows a DC-AC power converter with a conventional LCL filter and FIG. 9D depicts a DC-AC power converter with a proposed planar LCL filter.

The variety of power electronics converters may be used according to the present disclosure, including, but not limited to: non-isolated direct current-direct current (DC-DC) converters (buck and buck-boost); isolated DC-DC converters (resonant); and DC-AC converters (grid-tied).

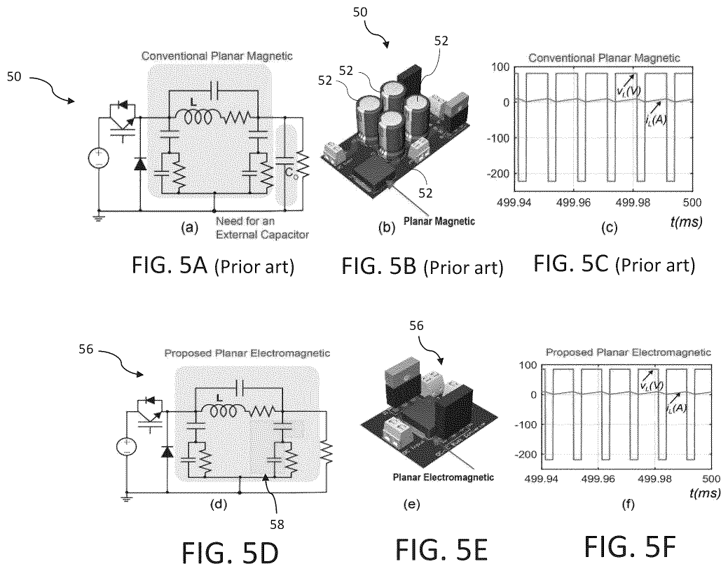

For example, FIGS. 5A-F show a comparison between a known converter that uses a traditional planar inductor and large capacitors and a DC-DC buck converter that uses the planar inductor built with CCRO according to the present disclosure.

FIG. 5A presents a schematic for known converter 50 in which the inductor is modeled with the main parasitic components presented in a known planar device. For correct operation, there is a need for an external capacitance C, that is implemented in this case by four bulky capacitors 52 as shown in FIG. 5B. In the design of the known planar device 50, all parasitic components are thought to be minimized (traditional approach). The results of FIG. 5C show voltage and current across the inductor for a 1 kW converter operating at 100 KHz.

FIG. 5D illustrates a circuit schematic for a converter comprising the PED 56 according to the present disclosure. A three-dimensional view of the converter with the PED 56 is shown in FIG. 5E. The converter 56 may include a planar inductor that may carry both inductive and capacitive features needed in a buck converter. As shown in FIG. 5D, the converter comprising the PED 56 may have the parasitic capacitors being maximized and therefore without the need for the external capacitance, as seen in FIG. 5E. The capacitance is still there but in this case it is provided by the parasitic capacitance boosted with CCTO NP dielectric material on the terminal connected to the load 58. As seen in FIG. 5C, the power processed by the traditional converter 50 in FIGS. 5A and 5B is about 1 kW. In FIG. 5F, the power processed by the converter including the PED 56 is also about 1 kW. The identical outcomes can be obtained with and without the presence of the external capacitance Cₒ. However, the converter including the PED 56 (FIG. 5E) has a volume reduction of around 40%. Thus, power electronics including the PED of the present disclosure may process the same amount of power as traditional power electronics while having a reduction of volume due to the utilization of both parasitic loads.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

We claim:

1. A planar electro-magnetic device, comprising:
at least two outer solder masks; and
a plurality of layers of copper sheets;
wherein each layer of copper sheet is spaced apart by at least one or a combination of a ferromagnetic core, an internal insulator, and a calcium copper titanate (CCTO) nanoparticle film;
wherein each of the plurality of layers of copper sheets are spaced apart between the first and second outer solder mask; and
wherein the planar converter has both inductive and capacitive characteristics.

2. The planar electro-magnetic device of claim 1, wherein the plurality of layers of copper sheets comprises a first layer of copper sheet, a second layer of copper sheet, a third layer of copper sheet, and a fourth layer of copper sheet,
wherein a first outer solder mask of the at least two outer solder masks is adjacent to a first surface of the first layer of copper sheet and a second outer solder mask of the at least two outer solder masks is adjacent to a second surface of the fourth layer of copper sheet, and
wherein the first layer of copper sheet is spaced apart from the second layer of copper sheet by a ferromagnetic core, and the third layer of copper sheet is spaced apart from the fourth layer of copper sheet by a ferromagnetic core.

3. The planar electro-magnetic device of claim 2, wherein the second layer of copper sheet is spaced apart from the third layer of copper sheet by a CCTO nanoparticle film.

4. The planar electro-magnetic device of claim 2, wherein a first side of the second layer of copper sheet is spaced apart from a first side of the third layer of copper sheet by an internal insulator, and a second side of the second layer of copper sheet is spaced apart from a second side of the third layer of copper sheet by a CCTO nanoparticle film.

5. The planar electro-magnetic device of claim 3, wherein the CCTO nanoparticle film comprises a dielectric material.

6. A power electronic device circuit, comprising:
a voltage source;
at least one resistor;
at least one inductor;
wherein the inductor comprises capacitive characteristics such that the power electronic device does not need an external capacitor; and
a planar electro-magnetic device (PED), the PED comprising:
at least two outer solder masks;
a calcium copper titanate (CCTO) nanoparticle film; and
a plurality of layers of copper sheets;
wherein each layer of copper sheet is spaced apart by at least one or a combination of a ferromagnetic core, an internal insulator, and the CCTO nanoparticle film;
wherein each of the plurality of layers of copper sheets are spaced apart between the first and second outer solder mask; and
wherein the PED has both inductive and capacitive characteristics.

7. The power electronic device of claim 6, wherein a parasitic capacitance in the at least one inductor is increased by the CCTO NP film layer within the PED.

8. A method of forming a calcium copper titanate (CCTO) nanoparticle film, comprising:
combining oleic acid (OLAc) and oleylamine (OLAm) to form a surface passivating ligand mixture;
heating the surface passivating ligand mixture to about 300° C.;
injecting metal alkoxide precursors into the surface passivating ligand mixture;
reacting the surface passivating ligand mixture with sulfide ions (S²⁻) to create a passivated CCTO nanoparticle;
dispersing the CCTO nanoparticle into an organic solvent to create a CCTO nanoparticle ink; and
spin coating the CCTO nanoparticle ink onto an aluminum foil to create a CCTP nanoparticle film with a controllable thickness.

9. The method of claim 8, wherein a composition of the CCTO nanoparticle film is homogeneous.

10. The method of claim 8, wherein the controllable thickness is between about 100-200 nm.

11. The method of claim 8, wherein the CCTO nanoparticle film is a dielectric material.
